(19) United States
(12) Patent Application Publication
(10) Pub. No.: US 2026/0037588 A1
(43) Pub. Date: Feb. 5, 2026

(54) PAGE DISPLAY METHOD AND APPARATUS, ELECTRONIC DEVICE, STORAGE MEDIUM, AND PROGRAM PRODUCT

(71) Applicant: CHENGDU GUANGHEXINHAO TECHNOLOGY CO., LTD., Sichuan Province, Chengdu (CN)

(72) Inventor: Ge CHEN, Beijing (CN)

(21) Appl. No.: 19/100,261

(22) PCT Filed: Aug. 1, 2023
(86) PCT No.: PCT/CN2023/110490

§ 371 Date: Jan. 31, 2025

(30) Foreign Application Priority Data
Aug. 2, 2022 (CN) 202210923073.2

(51) Int. Cl. G06F 16/9538; G06F 16/2457; G06F 16/9535

(52) U.S. Cl. CPC G06F 16/9538; G06F 16/24578; G06F 16/9535

(57) ABSTRACT

A method and apparatus, an electronic device, a storage medium, and a program product for page display are provided. The method for page display includes: displaying a first page (S101); in response to a search page display operation performed on the first page, switching a current page from the first page to a search page, wherein the search page is used for searching based on search information from a user (S102); and in response to a page return operation performed on the search page, switching the current page from the search page to a target page, and displaying associated content of a target topic on the target page, wherein the target topic is a media content topic associated with target search information, and the target search information is search information searched by the user in the search page (S103).

This application claims priority to Chinese Patent Application No. 202210923073.2, filed with the China National Intellectual Property Administration on Aug. 2, 2022, the disclosure of which is incorporated herein by reference in its entirety.

### FIELD

The present disclosure relates to the technical field of computers, and for example, to a method and apparatus, an electronic device, a storage medium, and a program product for page display.

### BACKGROUND

Users can input keywords into an input box of a search page and perform a search operation after inputting the keywords, to view search results corresponding to the keywords on the search page. In addition, after completing the searching, the users can exit the search page to view other content in an application program.

### SUMMARY

The present disclosure provides a method and apparatus, an electronic device, a storage medium, and a program product for page display, so that when a user exits a search page, content associated with search content on the search page is displayed, thereby improving the diversity of the content displayed when the user exits the search page and improving the information obtaining efficiency.

In a first aspect, the present disclosure provides a method for page display, including:
displaying a first page;
in response to a search page display operation performed on the first page, switching a current page from the first page to a search page, wherein the search page is used for searching based on search information from a user; and
in response to a page return operation performed on the search page, switching the current page from the search page to a target page, and displaying associated content of a target topic on the target page, wherein the target topic is a media content topic associated with target search information, and the target search information is search information searched by the user on the search page.

In a second aspect, the present disclosure further provides an apparatus for page display, including:
a page display module, configured to display a first page;
a search page switching module, configured to: in response to a search page display operation performed on the first page, switch a current page from the first page to a search page, wherein the search page is used for searching based on search information from a user; and
a target page switching module, configured to: in response to a page return operation performed on the search page, switch the current page from the search page to a target page, and display associated content of a target topic on the target page, wherein the target topic is a media content topic associated with target search information, and the target search information is search information searched by the user on the search page.

In a third aspect, the present disclosure further provides an electronic device, including:
one or more processors; and
a memory communicably connected with the one or more processors, wherein
the memory stores a computer program performed by the one or more processors, and the computer program, performed by the one or more processors, causes the one or more processors to perform the method for page display described above.

In a fourth aspect, the present disclosure further provides a computer-readable medium, having a computer program stored thereon, wherein the program, when performed by a processor, causes the processor to perform the method for page display described above.

In a fifth aspect, the present disclosure further provides a computer program product. The computer program product, when performed by a computer, causes the computer to perform the method for page display described above.

### BRIEF DESCRIPTION OF THE DRAWINGS

FIG. 1 is a flowchart of a method for page display according to an embodiment of the present disclosure;

FIG. 2 is a schematic diagram of displaying of a first page according to an embodiment of the present disclosure;

FIG. 3 is a schematic diagram of displaying of a search page according to an embodiment of the present disclosure;

FIG. 4 is a flowchart of another method for page display according to an embodiment of the present disclosure;

FIG. 5 is a schematic diagram of another displaying of a first page according to an embodiment of the present disclosure;

FIG. 6 is a schematic diagram of displaying of a second page according to an embodiment of the present disclosure;

FIG. 7 is a structural block diagram of a page display apparatus according to an embodiment of the present disclosure; and

FIG. 8 is a schematic structural diagram of an electronic device according to the embodiments of the present disclosure.

### DETAILED DESCRIPTION OF EMBODIMENTS

The embodiments of the present disclosure will be described below with reference to the accompanying drawings. Although the accompanying drawings show some embodiments of the present disclosure, the present disclosure can be implemented in various forms, and these embodiments are provided for understanding the present disclosure. The accompanying drawings and embodiments of the present disclosure are only used for illustration.

Multiple steps recorded in method implementations of the present disclosure can be executed in different orders and/or in parallel. In addition, the method implementations may include additional steps and/or omit the execution of the steps shown. The scope of the present disclosure is not limited in this aspect.

The term “include” and its variants as used herein mean widespread inclusion, namely, “including”. The term “based on” is “based at least in part on”. The term “one embodiment” means “at least one embodiment”. The term “another embodiment” means “at least another embodiment”. The term “some embodiments” means “at least some embodiments”. Relevant definitions of other terms will be given in the description below.

The concepts such as “first” and “second” mentioned in the present disclosure are only used to distinguish different apparatuses, modules, or units, and are not intended to limit the order or interdependence of the functions performed by these apparatuses, modules, or units.

The modifications of “one” and “plurality” mentioned in the present disclosure are indicative rather than restrictive, and those skilled in the art should understand that unless otherwise clearly stated in the context, they should be understood as “one or more”.

Messages or names of information interacted between a plurality of apparatuses in the implementations of the present disclosure are only for illustrative purposes and are not intended to limit the messages or the scope of the information.

Before use of the technical solutions disclosed in the embodiments of the present disclosure, users should be informed of the type, scope of use, usage scenarios, and the like of personal information involved in the present disclosure in accordance with relevant laws and regulations in an appropriate manner, so as to obtain authorization from the users.

For example, in response to that an active request of a user has been received, prompt information is sent to the user to clearly remind the user that personal information of the user needs to be involved in an operation requested to be executed. Thus, the user can independently select whether to provide the personal information to software or hardware such as an electronic device, an application program, a server, or a storage medium that performs the operation of the technical solutions of the present disclosure according to the prompt information.

As an implementation, in response to that an active request of a user has been received, prompt information is sent to the user through, for example, a pop-up window where the prompt information can be presented in text. In addition, the pop-up window can also carry a selection control for the user to select whether to “agree” or “refuse” to provide the personal information to the electronic device.

The above notification and the above user authorization obtaining process are only illustrative and do not constitute a limitation on the implementations of the present disclosure. Other methods that meet the relevant laws and regulations can also be applied to the implementations of the present disclosure.

In the related technologies, the application program displays relatively simple content when the users exit the search page, so that the information obtaining efficiency is low, which cannot meet needs of the users.

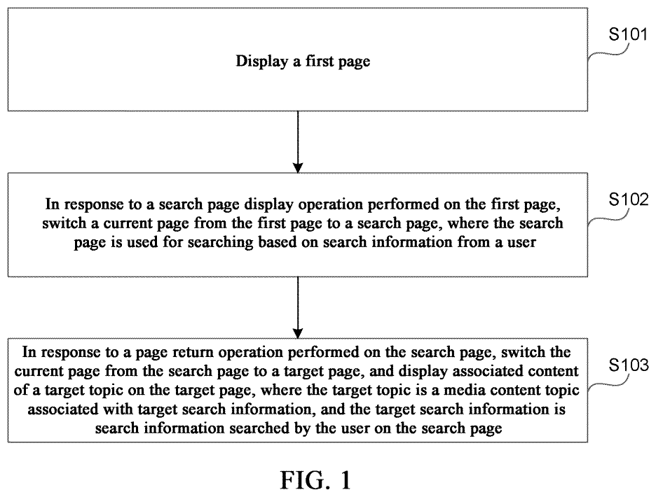

FIG. 1 is a flowchart of a method for page display according to an embodiment of the present disclosure. The method can be performed by an apparatus for page display. The apparatus can be implemented by software and/or hardware and can be configured in an electronic device, for example, in a mobile phone or a tablet. The method for page display provided in this embodiment of the present disclosure is applicable to a scenario for displaying, after a user exiting a search page, content associated with search information inputted by the user on the search page. As shown in FIG. 1, the method for page display provided in this embodiment may include:
S101. A first page is displayed.

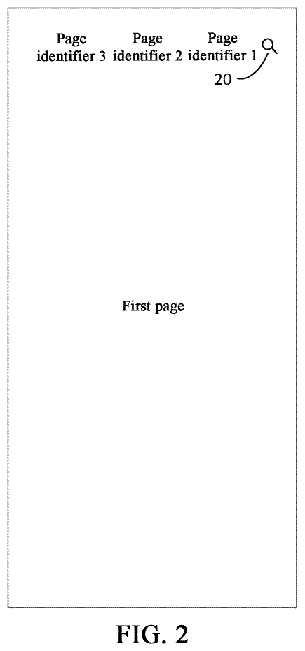

The first page can be a page that can be directly switched to a search page. A page identifier of the search page can be displayed on the first page, and/or the first page may be a page on which a search page display control triggered to input the search page is displayed. At least one-page identifier can be displayed on the first page. The page identifier can include, for example, the page identifier of the first page (page identifier 1 as shown in FIG. 2) and/or a page identifier of a second page. The page identifier can be used for triggering to display a page corresponding to the triggered page identifier. The first page can be a media content display page or another page. For example, it can be a page other than a detail page used for displaying detailed information of search result items in search results, such as a recommendation page used for playing recommended videos or a follow page used for playing media content posted by a poster that a user follows. Exemplarily, the first page may be a page aggregated in a homepage of an application program.

In this embodiment, the first page may be displayed based on a triggering operation performed by a user to display the first page, as shown in FIG. 2, so that the user can view content displayed on the first page.
S102. In response to a search page display operation performed on the first page, a current page is switched from the first page to a search page. The search page is used for searching based on search information from a user.

The search page display operation can be an operation used for indicating displaying of the search page, such as an operation of triggering the page identifier of the search page displayed on the first page or triggering a search page display control. The search page can be used by the user to input the search information that the user intends to search for and display a search result generated based on the search information inputted by the user. The search information may be information searched by the user on the search page, such as a keyword that is inputted by the user in an input box of the search page and needs to be searched.

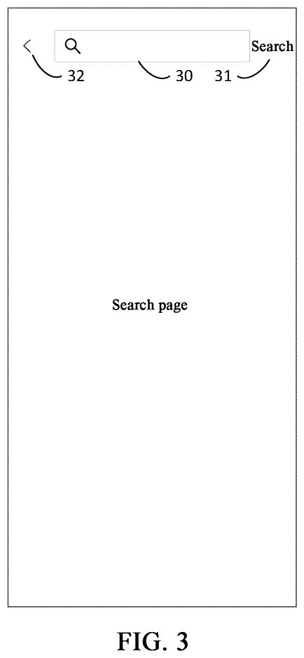

When the user intends to input the search page for searching, the user may perform the search page display operation on the first page, such as triggering a search page display control 20 (as shown in FIG. 2) displayed on the first page. Correspondingly, when receiving the search page display operation of the user, the application program can switch the current page from the first page to the search page, as shown in FIG. 3, to facilitate the user to search for content on the search page.

Continuing to refer to FIG. 3, the search page can display an input box 30 with the search information. Thus, the user can input the search information in the input box 30 and perform a search operation after completing inputting the search information, such as triggering a search control 31 displayed on the search page. Correspondingly, when receiving the search operation of the user, for example, when detecting that the user triggers the search control 31 on the search page, the application program may determine the search information inputted by the user in the input box 30, obtain the search result that matches the search information, and display the search result on the search page.

In addition, the search page can further display one or more candidate search information for selection by the user, such as recommended search information. In this case, by triggering a piece of candidate search information displayed on the search page, the user may also input the triggered candidate search information as the current search information into the input box of the search page. Correspondingly, when detecting that the user triggers a piece of candidate search information displayed on the search page, the application program may display, in the input box of the search page, the candidate search information triggered by the user, use the candidate search information as the search information from the user for searching, and display, on the search page, the search result that matches the search information.

The search result may include one or more search result items. After the search result is displayed on the search page, namely, after the search result items in the search result are displayed on the search page, the user may also trigger a search result item displayed on the search page to view detailed information of the search result item. In this case, when detecting that the user triggers a search result item displayed on the search page, the application program can expand the search result item on the search page to display detailed information of the search result item. Or, the current page can be switched from the search page to a detail page corresponding to the search result item/a plurality of search result items, and detailed information of the search result item can be displayed on the detail page. This embodiment does not limit this.
S103. In response to a page return operation performed on the search page, the current page is switched from the search page to a target page, and associated content of a target topic is displayed on the target page. The target topic is a media content topic associated with target search information, and the target search information is search information searched by the user on the search page.

The page return operation may be an operation used for returning to a page displayed before the user performs searching. Exemplarily, when the user performs the search page display operation on a page (e.g. the first page) aggregated on the homepage of the application program to input the search page, the page return operation may be used for indicating displaying of the page aggregated on the homepage of the application program (e.g. the first page or another page aggregated on the homepage except the first page). The page return operation may be an operation of triggering a return control displayed on the search page or an operation of sliding in a preset direction (e.g. to the right) on the search page.

The target search information may be search information with an associated media content topic. To avoid excessive interference to the user caused by displaying associated content of the target topic, the target search information may be search information with a media content topic having a relevance greater than a preset relevance threshold. In this case, a relevance between the target search information and the target topic is greater than the preset relevance threshold. For example, after the first page is switched to the search page at this time, the user may perform searching once or for multiple times, and the search information inputted during each searching may be different. If the search information from the user during searching after the first page is switched to the search page has the media content topic with the relevance greater than the preset relevance threshold, the search information obtained during this searching may be used as the target search information.

The target topic may be a media content topic associated with the target search information, or a media content topic with the relevance, to the target search information, greater than the preset relevance threshold. The media content topic may include, for example, food, leisure and entertainment, sightseeing, accommodation, sports and fitness, or shopping. When a plurality of target search information exist, one piece of target search information may be selected. This embodiment does not limit a selection mode for the target search information. For example, a piece of target search information can be selected randomly, and a media content topic (e.g. a media content topic with the largest relevance) corresponding to the target search information can be used as the target topic. Alternatively, a piece of target search information can be selected according to the last search time corresponding to the plurality of target search information and/or the relevance between plurality of target search information and their corresponding media content topics, and the corresponding media content topics are used as the target topics. The associated content of the target topic can be content associated with the target topic, such as prompt information associated with the target topic or media content under the target topic. The topic corresponding to the search information may be determined by the existing technology and will not be limited here.

The target page can be the first page, the second page, or a third page except the first page and the second page, which can be set as needed. For example, the target page can be the first page or another page aggregated with the first page on the same page (e.g. the homepage), such as the second page or the third page. Exemplarily, if the target topic associated with the search information searched by the user on the search page exists, the target page may include the first page and/or the second page. If the target topic associated with the search information searched by the user on the search page does not exist, the target page may include the first page and/or the third page. The third page may be a page displayed by default, such as a page displayed by default when inputting the homepage of the application program.

After completing the searching, the user may exit the search page by performing the page return operation, such as triggering a return control 32 displayed on the search page, as shown in FIG. 3. Correspondingly, when receiving the page return operation performed on the search page, for example, when detecting that the user triggers the return control 32 on the search page, the application program may switch the current page from the search page to the target page, and display, on the target page, the associated content of the target topic associated with the target search information searched by the user on the search page, such as displaying, on the target page, prompt information associated with the target topic, or displaying, on the target page, media content using the target topic as the corresponding media content topic.

In this embodiment, there is no necessary connection between the associated content of the target topic displayed on the target page and a target search result obtained by the user by searching the target search information on the search page. For example, when the target search result is empty, the associated content of the target topic can be displayed on the target page. Alternatively, when the target search result is not empty, the associated content of the target topic displayed on the target page may include one or more search result items in the target search result, or may not include a search result item in the target search result.

In this embodiment, when the user exits the search page after completing the searching on the search page, the associated content of the target topic corresponding to the target search information searched by the user on the search page is displayed, which can enrich interaction modes for the user to obtain search related information, improve the diversity of content displayed when the user exits the search page, and enable the user to continue to watch the content associated with the target topic corresponding to the search information searched by the user. This may improve the relevance between the displayed content before and after exiting the search page and enhance the user experience.

In an implementation, the target search information may be search information that has been searched by the on the search page. In this case, after the current page is switched from the first page to a search page, the method further includes: in response to a search operation performed on the target search information, a target search result obtained by searching based on the target search information is displayed on the search page. The search operation may be an operation of triggering a search control in the search page after inputting the target search information into the input box, or an operation of triggering the target search information displayed on the search page (in a case that the target search information is a piece of candidate search information displayed on the search page).

In this embodiment, the search result items included in the target search result that matches the target search information during the searching on the search page may not be considered. When the current page is switched from the search page to the target page, the associated content of the target topic is directly displayed on the target page. Exemplarily, when the second page is a page associated with a region, for example, when the second page is a page used for playing media content posted in a city (e.g. the city where the current user is or a preset city) and/or media content related to the city, the target search result may not be considered. When the current page is switched from the search page to the target page, the associated content of the target topic is directly displayed directly on the target page.

In addition, the search result items included in the target search result that matches the target search information during the searching on the search page may alternatively be considered. Only if the target search result contains a target search result item that is consistent with the second page, when the current page is switched from the search page to the target page, the associated content of the target topic is displayed on the target page. If the target search result does not contain the target search result item that is consistent with the second page, when the current page is switched from the search page to the target page, the associated content of the target topic is not displayed on the target page.

In this case, the current page is switched from the search page to a target page, and associated content of a target topic is displayed on the target page, and it includes: if a target search result obtained by searching based on the target search information contains a target search result item, the current page is switched from the search page to the target page, and the associated content of the target topic is displayed on the target page. Region information corresponding to the target search result item is consistent with region information corresponding to the second page.

The target search result may be a search result that is obtained by searching for the target search information on the search page and matches the target search information. The target search result item may be, in the target search result, a search result item with the corresponding region information conforming to the region information corresponding to the second page.

Exemplarily, after the target search information is determined, it may determine whether the plurality of search result items included in the target search result of the target search information include the target search result item with the corresponding region information conforming to the region information corresponding to the second page. If the plurality of search result items included in the target search result of the target search information include the target search result item with the corresponding region information conforming to the region information corresponding to the second page, when the page return operation performed on the search page is received, the associated content of the target topic is displayed on the target page. If the plurality of search result items included in the target search result of the target search information do not include the target search result item with the corresponding region information conforming to the region information corresponding to the second page, when the page return operation performed on the search page is received, the associated content of the target topic is not displayed on the target page.

The presence of the target search result item in the target search result mentioned herein is only an exemplary limitation on a display condition of the associated content of the target topic, and does not limit the inclusion of the target search result in the associated content. For example, even if the target search result includes the target search result item, the associated content of the target topic may or may not include the target search result item. There is no necessary connection between them. The region information is obtained on the premise that the relevant user has authorized. If the user has not authorized it, the relevant regional information will not be obtained.

According to the method for page display provided in this embodiment, a first page is displayed; in response to a search page display operation performed on the first page, a current page is switched from the first page to a search page, wherein the search page is used for searching based on search information from a user; and in response to a page return operation performed on the search page, the current page is switched from the search page to a target page, and associated content of a target topic is displayed on the target page, wherein the target topic is a media content topic associated with target search information, and the target search information is search information searched by the user on the search page. In this embodiment, by the use of the above technical solution, when the user exits the search page after completing the searching on the search page, the associated content of the target topic corresponding to the target search information searched by the user on the search page is displayed, which can enrich interaction modes for the user to obtain search related information, improve the diversity of content displayed when the user exits the search page and the relevance between the displayed content before and after exiting the search page, enhance the user experience, and improve the information obtaining efficiency.

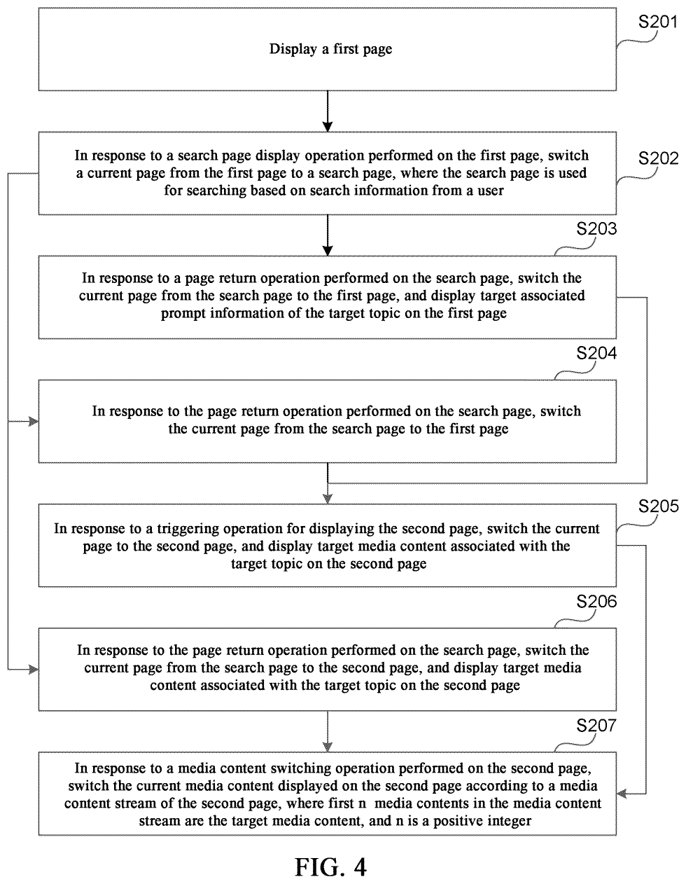

FIG. 4 is a flowchart of another method for page display according to an embodiment of the present disclosure. The solution in this embodiment may be combined with one or more solutions in the above embodiment. The target page includes the first page. The current page is switched from the search page to a target page, and associated content of a target topic is displayed on the target page, and it includes: the current page is switched from the search page to the first page, and target associated prompt information of the target topic is displayed on the first page. The target associated prompt information is used for prompting to watch media content associated with the target topic on a second page.

After target associated prompt information of the target topic is displayed on the first page, the method further includes: in response to a triggering operation for displaying the second page, the current page is switched to the second page, and target media content associated with the target topic is displayed on the second page.

The target page includes a second page; and the current page is switched from the search page to a target page, and associated content of a target topic is displayed on the target page, and it includes: the current page is switched from the search page to the second page, and target media content associated with the target topic is displayed on the second page.

The target page includes a second page; and in response to a page return operation performed on the search page, the current page is switched from the search page to a target page, and associated content of a target topic is displayed on the target page, which includes: In response to the page return operation performed on the search page, the current page is switched from the search page to the first page; and in response to a triggering operation for displaying the second page, the current page is switched to the second page, and target media content associated with the target topic is displayed on the second page.

After target media content associated with the target topic is displayed on the second page, the method further includes: In response to a media content switching operation performed on the second page, the current media content displayed on the second page is switched according to a media content stream of the second page. First n media content in the media content stream are the target media content, and n is a positive integer.

Correspondingly, as shown in FIG. 4, the method for page display provided in this embodiment may include:
S201. A first page is displayed.
S202. In response to a search page display operation performed on the first page, a current page is switched from the first page to a search page, and S203, S204, or S206 is executed. The search page is used for searching based on search information from a user.
S203. In response to a page return operation performed on the search page, the current page is switched from the search page to the first page, and target associated prompt information of the target topic is displayed on the first page. S205 is executed. The target associated prompt information is used for prompting to watch media content associated with the target topic on a second page.

In this embodiment, the target page may include the first page which is a page displayed before the search page is displayed in response to the search page display operation. Associated content of the target topic may include the target associated prompt information of the target topic. The target associated prompt information may be prompt information that prompts the user to watch media content associated with the target topic on a page (e.g. a second page).

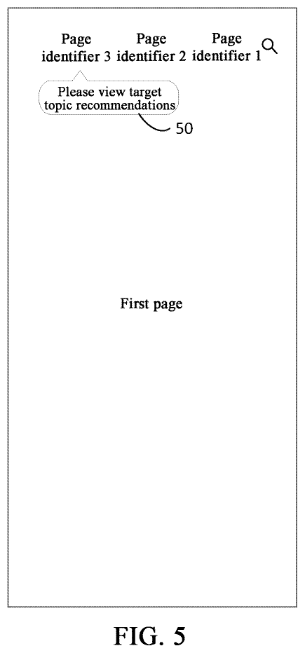

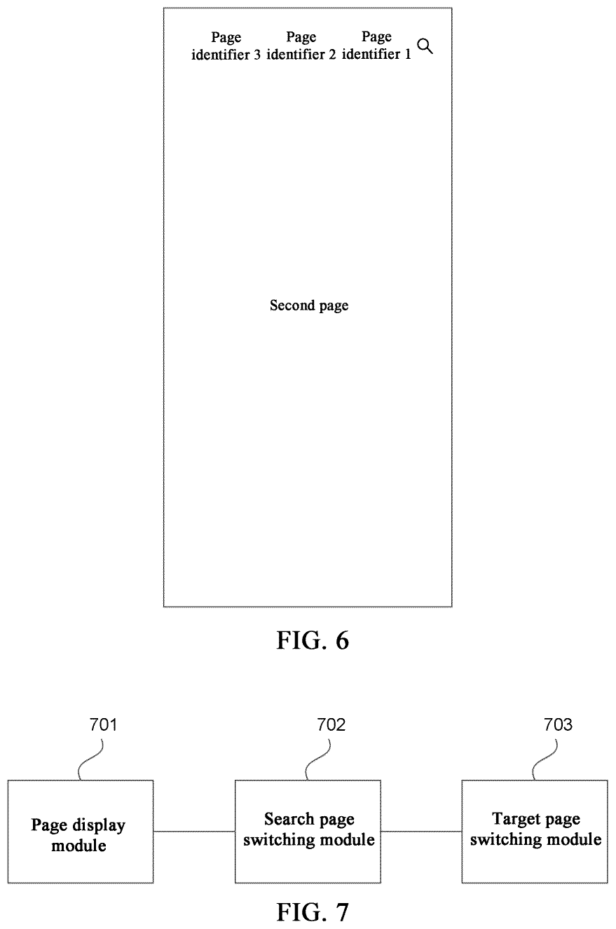

Exemplarily, when the page return operation performed on the search page is received, the current page can be switched from the search page to the first page, and target associated prompt information 50 of the target topic can be displayed on the first page, as shown in FIG. 5, to prompt, through the target associated prompt information 50, the user to watch the media content associated with the target topic on the second page (a page corresponding to page identifier 3 in FIG. 5), such as the media content using the target topic as the corresponding media content topic. This may guide the user to input the second page to quickly obtain the media content associated with the target topic, which can improve the media content obtaining efficiency and enhance the user experience.

In this embodiment, a display position of the target associated prompt information on the first page may be set as needed. For example, the target associated prompt information may be displayed at a position associated or not associated with a page identifier of the second page. The target associated prompt information may be displayed at a position associated with the page identifier of the second page to prompt the user to switch to the second page by triggering the page identifier of the second page. In this case, the page identifier of the first page and the page identifier of the second page are displayed on the first page. Target associated prompt information of the target topic is displayed on the first page, which includes: The target associated prompt information of the target topic is displayed at a display position corresponding to the page identifier of the second page. The page identifier is used for being triggered to display the page corresponding to the triggered page identifier.

In this embodiment, the number of display times of the target associated prompt information may not be considered. After the user searches for target search information with an associated target topic on the search page, namely, when the page return operation performed on the search page is received, the first page is displayed, and the target associated prompt information is displayed on the first page.

To avoid excessive interference to the user caused by the displaying of the target associated prompt information, this embodiment may only display the target associated prompt information on the first page when a total number of display times of associated prompt information in a current prompt cycle does not reach a preset number of times. However, if the total number of display times of the associated prompt information in the current prompt cycle reaches the preset number of times, regardless of whether the user has searched for the target search information with the associated target topic on the search page, the target associated prompt information will not be displayed on the first page when the first page is displayed. At this time, target associated prompt information of the target topic is displayed on the first page, which includes: If a total number of display times of associated prompt information of a media content topic within the current prompt cycle does not reach the preset number of times, the target associated prompt information of the target topic is displayed on the first page. The associated prompt information includes the target associated prompt information.

The current prompt cycle can be set as needed. For example, prompt cycles can be divided by day, week, and/or month. For example, today, this week, and/or this month is used as the current prompt cycle. The preset prompt threshold can be flexibly set. For example, the preset number of times can be set to be 1 or 3. The associated prompt information of a media content topic can be prompt information used for prompting the user to watch media content related to the media content topic on the second page. The associated prompt information may include the target associated prompt information of the target topic.

The current prompt cycle including this week and today is taken as an example. When the page return operation performed on the search page is received, it can determine whether the number of display times of the associated prompt information in this week has reached a first preset number of times (e.g. 3) and whether the number of display times of the associated prompt information within today has reached a second preset number of times (e.g. 1). If the number of display times of the associated prompt information in this week has not reached the first preset number of times and the number of display times of the associated prompt information within today has not reached the second preset number of times, the first page is displayed, and the target associated prompt information is displayed on the first page. If the number of display times of the associated prompt information in this week has not reached the first preset number of times or the number of display times of the associated prompt information within today has not reached the second preset number of times, the first page is displayed, and the target associated prompt information is not displayed on the first page.

In addition, whether the user has inputted the second page within a set cycle (e.g. today) may be considered too. If the user has inputted the second page within the set cycle, the target associated prompt information may not be displayed on the first page, to reduce the interference with the user caused by the displaying of the target associated prompt information.
S204. In response to the page return operation performed on the search page, the current page is switched from the search page to the first page.

In this embodiment, the target page may include the second page. When the page return operation performed on the second page is received, the current page can be switched from the first page to the second page. For example, the first page is displayed first, and when a triggering operation for displaying the second page, which is performed by the user, is received, the second page is then displayed. In this case, when the first page is displayed, the associated content of the target topic may not be displayed on the first page. For example, the target associated prompt information is not displayed on the first page.

Exemplarily, when the page return operation performed on the search page is received, the current page may be switched from the search page to the first page, as shown in FIG. 2.
S205. In response to a triggering operation for displaying the second page, the current page is switched to the second page, and target media content associated with the target topic is displayed on the second page, and S207 is executed.

In this embodiment, the target page may include the second page. When the triggering operation for displaying the second page is received, regardless of whether the target associated prompt information is displayed on the first page, the current page can be switched to the second page, and the target media content associated with the target topic can be displayed on the second page for watching by the user. The target media content associated with the target topic belongs to media content associated with the target topic. The target media content associated with the target topic is media content associated with the target topic and displayed on the second page. For example, the target media content associated with the target topic is media content using the target topic as its media content topic, which may be video content, image-text content, music content, or the like. The second page and the first page can be different pages.

In this embodiment, when both the first page and the second page are the target pages, whether the target association prompt is displayed on the first page may not be considered. When the triggering operation for displaying the second page is received, the second page is displayed, and the target media content is displayed on the second page. Alternatively, whether the target associated prompt information is displayed on the first page may be considered. In a case that the target associated prompt information is displayed on the first page only, when the triggering operation for displaying the second page is received, the second page is displayed, and the target media content is displayed on the second page. In a case that the target associated prompt information is not displayed on the first page, when the triggering operation for displaying the second page is received, the second page is displayed, and any content used for playing is displayed on the second page. For example, a media content stream including media content with different media content topics is generated according to recommendation priorities corresponding to different media content topics, and the first piece of media content in the media content stream is displayed on the second page.
S206. In response to the page return operation performed on the search page, the current page is switched from the search page to the second page, and target media content associated with the target topic is displayed on the second page.

In this embodiment, the target page may include the second page. When the page return operation performed on the search page is received, the current page may be directly switched to the second page, and the target media content associated with the target topic can be displayed on the second page for watching by the user.

For example, the first page may be used for displaying a first type of video stream, and the second page may be used for displaying a second type of video stream. In an implementation, the second type of video stream may be a subset of the first type of video stream, or the second type of video stream may have an intersection with the first type of video stream. For example, the first page may be a recommendation page; the second page may be a local page; the first type of video stream may be a video stream including a plurality of different regions; and the second type of video stream may be a video stream of a region that satisfies a preset condition. The preset condition may be that a region corresponding to the second type of video stream is a region where the user is or a region set by the user. Therefore, the second type of video stream may be a video stream of the region where the user is or a video stream of the region set by the user. For example, the region may be a region corresponding to video content displayed in the video stream, such as a region corresponding to a commodity in a video. The plurality of regions corresponding to the first type of video stream may include the region corresponding to the second type of video stream. Thus, it is convenient for the user to quickly obtain videos, related to the search information, in the video stream of the region that satisfies the preset condition, to enhance the user experience.
S207. In response to a media content switching operation performed on the second page, the current media content displayed on the second page is switched according to a media content stream of the second page. First n media contents in the media content stream are the target media content, and n is a positive integer.

In this embodiment, when the second page is initially switched, the target media content associated with the target topic may be displayed on the second page, and the current media content displayed on the second page may be switched according to the media content stream of the second page in response to the media content switching operation performed by the user. The media content displayed on the second page after switching may be the target media content associated with the target topic, or other media content except the target media content. Where n can be flexibly set as needed. For example, n is set to 1, 3, or the like.

Exemplarily, when the second page is displayed in response to the page return operation or the triggering operation for displaying the second page as described above, the media content stream of the second page can be generated; the first n media contents in the media content stream can be configured as the target media content; the second page can be displayed; and the first piece of media content in the media content stream can be displayed on the second page. Afterwards, when the media content switching operation is received, the current media content displayed on the second page can be switched according to an arrangement sequence of a plurality of media contents in the media content stream. For example, the current media content is switched to media content, adjacent to the media content displayed on the second page before switching, in the media content stream.

In an implementation, when the media content stream of the second page is generated in response to the page return operation or the triggering operation for displaying the second page as described above, the first n media contents in the media content stream of the second page may be the target media content, and at least some of the media content in the media content stream of the second page except the first n media content may not be the target media content. For example, the media content in the media content stream except the first n media content can be determined according to the recommendation priorities corresponding to different media content topics.

In addition, the recommendation priority corresponding to the target topic can be increased, and the media content in the media content stream except the first n media contents can be determined according to the increased recommendation priority corresponding to the target topic and the recommendation priorities corresponding to other media content topics except the target topic, to generate the media content stream of the second page. At this point, before target media content associated with the target topic is displayed on the second page, the method further includes: the recommendation priority corresponding to the target topic is increased; and the media content stream of the second page is generated based on the increased recommendation priority corresponding to the target topic and the recommendation priorities of other media content topics except the target topic.

In another implementation, when the media content stream of the second page is generated in response to the page return operation or the triggering operation for displaying the second page as described above, the first n media contents in the media content stream of the second page may be the target media content, and media content in the media content stream of the second page except the first n media content may all be the target media content. Namely, all the media contents in the media content stream are the target media content. In this case, after target media content associated with the target topic is displayed on the second page, the method further includes: In response to a media content switching operation performed on the second page, the current media content displayed on the second page is switched according to the media content stream of the second page. All the media contents in the media content stream are the target media content.

According to the method for page display provided in this embodiment, when the user exits the search page, the target associated prompt information of the target topic associated with the target search information searched by the user can be displayed on the first page, and/or, the target media content associated with the target topic is displayed on the second page, so that the diversity of content displayed when the user exits the search page and the relevance between content displayed before and after exiting the search page can be improved, and the information obtaining efficiency can be improved.

FIG. 7 is a structural block diagram of a page display apparatus according to an embodiment of the present disclosure. The apparatus can be implemented by software and/or hardware and can be configured in an electronic device, a mobile phone, or a tablet. By performing the method for page display, content associated with search information searched by a user on a search page can be displayed after exiting the search page. As shown in FIG. 7, the apparatus for page display provided in this embodiment may include: a page display module 701, a search page switching module 702, and a target page switching module 703. The page display module 701 is configured to display a first page; the search page switching module 702 is configured to in response to a search page display operation performed on the first page, switch a current page from the first page to a search page, wherein the search page is used for searching based on search information from a user; and the target page switching module 703 is configured to in response to a page return operation performed on the search page, switch the current page from the search page to a target page, and display associated content of a target topic on the target page, wherein the target topic is a media content topic associated with target search information, and the target search information is search information searched by the user on the search page.

According to the apparatus for page display provided in this embodiment, through the page display module, a first page is displayed; through the search page switching module, in response to a search page display operation performed on the first page, a current page is switched from the first page to a search page, wherein the search page is used for searching based on search information from a user; and through the target page switching module, in response to a page return operation performed on the search page, the current page is switched from the search page to a target page, and associated content of a target topic is displayed on the target page, wherein the target topic is a media content topic associated with target search information, and the target search information is search information searched by the user on the search page. In this embodiment, by the use of the above technical solution, when the user exits the search page after completing the searching on the search page, the associated content of the target topic corresponding to the target search information searched by the user on the search page is displayed, which can enrich interaction modes for the user to obtain search related information, improve the diversity of content displayed when the user exits the search page and the relevance between the displayed content before and after exiting the search page, enhance the user experience, and improve the information obtaining efficiency.

In the above solution, the target page includes the first page; and the target page switching module 703 may be configured to switch the current page from the search page to the first page, and display target associated prompt information of the target topic on the first page. The target associated prompt information is used for prompting to watch media content associated with the target topic on a second page.

In the above solution, a page identifier of the first page and a page identifier of the second page can be displayed on the first page; and the target page switching module 703 can be configured to display the target associated prompt information of the target topic at a display position corresponding to the page identifier of the second page. The page identifier is used for being triggered to display the page corresponding to the triggered page identifier.

In the above solution, the target page switching module 703 can be configured to: if a total number of display times of associated prompt information of a media content topic within a current prompt cycle does not reach a preset number of times, display the target associated prompt information of the target topic on the first page. The associated prompt information includes the target associated prompt information.

The apparatus for page display provided in this embodiment can further include: a second page switching module, configured to: after the displaying target associated prompt information of the target topic on the first page, in response to a triggering operation for displaying the second page, switch the current page to the second page, and display target media content associated with the target topic on the second page.

In the above solution, the target page can include a second page; and the target page switching module 703 can be configured to: switch the current page from the search page to the second page, and display target media content associated with the target topic on the second page.

In the above solution, the target page can include a second page; and the target page switching module 703 can be configured to: in response to the page return operation performed on the search page, switch the current page from the search page to the first page; and in response to a triggering operation for displaying the second page, switch the current page to the second page, and display target media content associated with the target topic on the second page.

The apparatus for page display provided in this embodiment can further include: a first media content switching module, configured to after the displaying target media content associated with the target topic on the second page, in response to a media content switching operation performed on the second page, switch, according to a media content stream of the second page, the current media content displayed on the second page. First n media contents in the media content stream are the target media content, and n is a positive integer.

The apparatus for page display provided in this embodiment can further include: an increase module, configured to before displaying target media content associated with the target topic on the second page, increase a recommendation priority corresponding to the target topic; and generate the media content stream of the second page based on the increased recommendation priority corresponding to the target topic and recommendation priorities of other media content topics except the target topic.

The apparatus for page display provided in this embodiment can further include: a second media content switching module, configured to after the displaying target media content associated with the target topic on the second page, in response to a media content switching operation performed on the second page, switch, according to a media content stream of the second page, the current media content displayed on the second page. All media contents in the media content stream can be the target media content.

In the above solution, the target page switching module 703 can be configured to if a target search result obtained by searching based on the target search information contains a target search result item, switch the current page from the search page to the target page, and display the associated content of the target topic on the target page. Region information corresponding to the target search result item is consistent with region information corresponding to the second page.

In the above solution, a relevance between the target search information and the target topic can be greater than a preset relevance threshold.

The apparatus for page display provided in this embodiment can further include: a search module, configured to: after the switching a current page from the first page to a search page, in response to a search operation performed on the target search information, display, on the search page, a target search result obtained by searching based on the target search information.

The apparatus for page display provided in this embodiment of the present disclosure may perform the method for page display provided in any embodiment of the present disclosure, and includes corresponding functional modules for implementing the method for page display and corresponding effects. For technical details not described in this embodiment, refer to the method for page display provided in any embodiment of the present disclosure.

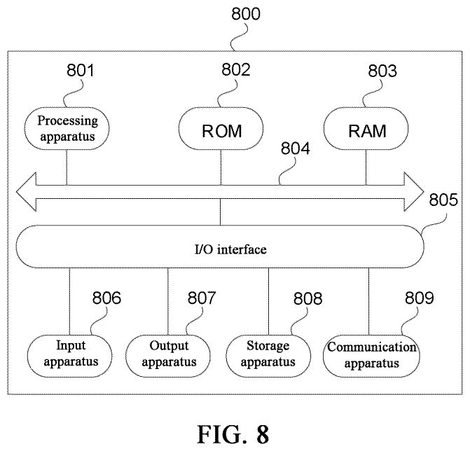

Reference is now made to FIG. 8 below, which illustrates a schematic structural diagram of an electronic device (namely, a terminal device) 800 suitable for implementing an embodiment of the present disclosure. The terminal device in the embodiments of the present disclosure may include a mobile phone, a laptop, a digital broadcast receiver, a Personal Digital Assistant (PDA), a Portable Android Device (PAD), a Portable Media Player (PMP), a mobile terminal such as a vehicle-mounted terminal (for example, a vehicle-mounted navigation terminal), and a fixed terminal such as digital television (TV) and a desktop computer. The electronic device 800 shown in FIG. 8 is only an example and should not impose any limitations on the functionality and scope of use of the embodiments of the present disclosure.

As shown in FIG. 8, the electronic device 800 may include a processing apparatus (such as a central processing unit and graphics) 801 that can perform various appropriate actions and processing according to programs stored in a Read-Only Memory (ROM) 802 or loaded from a storage apparatus 808 to a Random Access Memory (RAM) 803. Various programs and data required for operations of the electronic device 800 may also be stored in the RAM 803. The processing apparatus 801, the ROM 802, and the RAM 803 are connected to each other through a bus 804. An Input/Output (I/O) interface 805 is also connected to the bus 804.

Usually, following apparatuses can be connected to the I/O interface 805: an input apparatus 806 including a touch screen, a touchpad, a keyboard, a mouse, a camera, a microphone, an accelerometer, a gyroscope, and the like; an output apparatus 807 including a Liquid Crystal Display (LCD), a speaker, a vibrator, and the like; a memory 808 including a magnetic tape, a hard disk drive, and the like; and a communication apparatus 809. The communication apparatus 809 can allow the electronic device 800 to wirelessly or wiredly communicate with other devices to exchange data. Although FIG. 8 shows the electronic device 800 with various apparatuses, the electronic device 800 is not required to implement or have all the apparatuses shown, and can alternatively implement or have more or fewer apparatuses.

According to the embodiments of the present disclosure, the process described in the reference flowchart above may be implemented as a computer software program. For example, the embodiments of the present disclosure include a computer program product, including a computer program carried on a non-transitory computer-readable medium, and the computer program includes program codes used for performing the methods shown in the flowcharts. In such an embodiment, the computer program may be downloaded and installed from a network through the communication apparatus 809, or installed from the storage apparatus 808, or installed from the ROM 802. When the computer program is executed by the processing apparatus 801, the above-mentioned functions defined in the methods of the embodiments of the present disclosure are executed.

The computer-readable medium mentioned in the present disclosure can be a computer-readable signal medium, a computer-readable storage medium, or any combination of the computer-readable signal medium and the computer-readable storage medium. The computer-readable storage medium can be, for example, electric, magnetic, optical, electromagnetic, infrared, or semiconductor systems, apparatuses, or devices, or any combination of the above. Examples of the computer-readable storage medium may include: an electrical connection with one or more wires, a portable computer disk, a hard disk drive, a RAM, a ROM, an Erasable Programmable Read Only Memory (EPROM or flash memory), an optical fiber, a Compact Disc Read-Only Memory (CD-ROM), an optical storage device, a magnetic storage device, or any suitable combination of the above components. In the present disclosure, the computer-readable storage medium may be any tangible medium that contains or stores a program, and the program can be used by or in combination with an instruction execution system, apparatus, or device. In the present disclosure, the computer-readable signal media may include data signals propagated in a baseband or as part of a carrier wave, which carries computer-readable program codes. The propagated data signals can be in various forms, including: electromagnetic signals, optical signals, or any suitable combination of the above. The computer-readable signal medium may also be any computer-readable medium other than a computer-readable storage medium. The computer-readable signal medium can send, propagate, or transmit programs for use by or in combination with an instruction execution system, apparatus, or device. The program codes included in the computer-readable medium can be transmitted using any suitable medium, including: a wire, an optical cable, a Radio Frequency (RF), and the like, or any suitable combination of the above.

In some implementations, clients and servers can communicate using any currently known or future developed network protocol such as a HyperText Transfer Protocol (HTTP), and can intercommunicate and be interconnected with digital data in any form or medium (for example, a communication network). Examples of the communication network include a Local Area Network (LAN), a Wide Area Network (WAN), an internet (such as an Internet), a point-to-point network (such as an ad hoc point-to-point network, and any currently known or future developed network.

The computer-readable medium may be included in the electronic device or exist alone and is not assembled into the electronic device.

The computer-readable medium carries one or more programs. When the one or more programs are performed by the electronic device, the electronic device is caused to: display a first page; in response to a search page display operation performed on the first page, switch a current page from the first page to a search page, wherein the search page is used for searching based on search information from a user; and in response to a page return operation performed on the search page, switch the current page from the search page to a target page, and display associated content of a target topic in the target page, wherein the target topic is a media content topic associated with target search information, and the target search information is search information searched by the user on the search page.

Computer program codes for performing the operations of the present disclosure may be written in one or more programming languages or a combination thereof. The above programming languages include an object-oriented programming language such as Java, Smalltalk, and C++, and conventional procedural programming languages such as “C” language or similar programming languages. The program codes may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks, including a LAN or a WAN, or can be connected to an external computer (for example, through an Internet using an Internet service provider).

The flowcharts and block diagrams in the accompanying drawings illustrate possible system architectures, functions, and operations that may be implemented by a system, a method, and a computer program product according to various embodiments of the present disclosure. In this regard, each block in a flowchart or a block diagram may represent a module, a program, or a part of a code. The module, the program, or the part of the code includes one or more executable instructions used for implementing specified logic functions. In some implementations used as substitutes, functions annotated in blocks may alternatively occur in a sequence different from that annotated in an accompanying drawing. For example, actually two blocks shown in succession may be performed basically in parallel, and sometimes the two blocks may be performed on a reverse sequence. This is determined by a related function. It is also noted that each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

The units described in the embodiments of the present disclosure can be implemented through software or hardware. The name of a module does not constitute a limitation on the unit itself in one case.

The functions described herein above may be performed, at least in part, by one or a plurality of hardware logic components. For example, non-restrictively, example types of hardware logic components that can be used include: a Field Programmable Gate Array (FPGA), an Application Specific Integrated Circuit (ASIC), Application Specific Standard Parts (ASSP), a System on Chip (SOC), a Complex Programmable Logic Device (CPLD), and the like.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include an electronic, magnetic, optical, electromagnetic, infrared, or semiconductor system, apparatus, or device, or any suitable combination of the above content. Examples of the machine-readable storage medium may include an electrical connection based on one or more wires, a portable computer disk, a hard disk drive, a RAM, a ROM, an EPROM or flash memory, an optical fiber, a CD-ROM, an optical storage device, a magnetic storage device, or any suitable combinations of the above contents.

According to one or more embodiments of the present disclosure, example 1 provides a method for page display, including:
displaying a first page;
in response to a search page display operation performed on the first page, switching a current page from the first page to a search page, wherein the search page is used for searching based on search information from a user; and
in response to a page return operation performed on the search page, switching the current page from the search page to a target page, and displaying associated content of a target topic on the target page, wherein the target topic is a media content topic associated with target search information, and the target search information is search information searched by the user on the search page.

According to one or more embodiments of the present disclosure, example 2 provides the method according to example 1. The target page includes the first page; and switching the current page from the search page to a target page, and displaying associated content of a target topic on the target page includes:
switching the current page from the search page to the first page, and displaying target associated prompt information of the target topic on the first page, wherein the target associated prompt information is used for prompting to watch media content associated with the target topic on a second page.

According to one or more embodiments of the present disclosure, example 3 provides the method according to example 2,

A page identifier of the first page and a page identifier of the second page are displayed on the first page; and displaying target associated prompt information of the target topic on the first page includes:
displaying the target associated prompt information of the target topic at a display position corresponding to the page identifier of the second page, wherein the page identifier is used for triggering to display the page corresponding to the triggered page identifier.

According to one or more embodiments of the present disclosure, example 4 provides the method according to example 2, displaying target associated prompt information of the target topic on the first page includes:
if a total number of display times of associated prompt information of a media content topic within a current prompt cycle does not reach a preset number of times, displaying the target associated prompt information of the target topic on the first page, wherein the associated prompt information includes the target associated prompt information.

According to one or more embodiments of the present disclosure, example 5 provides the method according to example 2, After displaying target associated prompt information of the target topic on the first page, the method further includes:
in response to a triggering operation for displaying the second page, switching the current page to the second page, and displaying target media content associated with the target topic on the second page.

According to one or more embodiments of the present disclosure, example 6 provides the method according to example 1, the target page includes the first page; and the switching the current page from the search page to a target page, and displaying associated content of a target topic on the target page includes:
switching the current page from the search page to the second page, and displaying target media content associated with the target topic on the second page.

According to one or more embodiments of the present disclosure, example 7 provides the method according to example 1, the target page includes a second page; and the in response to a page return operation performed on the search page, switching the current page from the search page to a target page, and displaying associated content of a target topic on the target page includes:
in response to the page return operation performed on the search page, switching the current page from the search page to the first page; and
in response to a triggering operation for displaying the second page, switching the current page to the second page, and displaying target media content associated with the target topic on the second page.

According to one or more embodiments of the present disclosure, example 8 provides the method according to any of examples 5 to 7, after displaying target media content associated with the target topic on the second page, the method further includes:
in response to a media content switching operation performed on the second page, switching, according to a media content stream of the second page, the current media content displayed on the second page, wherein first n media contents in the media content stream are the target media content, and n is a positive integer.

According to one or more embodiments of the present disclosure, example 9 provides the method according to example 8, before displaying target media content associated with the target topic on the second page, the method further includes:
increasing a recommendation priority corresponding to the target topic; and
generating the media content stream of the second page based on the increased recommendation priority corresponding to the target topic and recommendation priorities of other media content topics except the target topic.

According to one or more embodiments of the present disclosure, example 10 provides the method according to any of examples 5 to 7,
before displaying target media content associated with the target topic on the second page, the method further includes:
in response to a media content switching operation performed on the second page, switching, according to a media content stream of the second page, the current media content displayed on the second page, wherein all media contents in the media content stream are the target media content.

According to one or more embodiments of the present disclosure, example 11 provides the method according to any of examples 1 to 7, the target page includes the first page; and switching the current page from the search page to a target page, and displaying associated content of a target topic on the target page includes:
if a target search result obtained by searching based on the target search information contains a target search result item, switching the current page from the search page to the target page, and displaying the associated content of the target topic on the target page, wherein region information corresponding to the target search result item is consistent with region information corresponding to the second page.

According to one or more embodiments of the present disclosure, example 12 provides the method according to any of examples 1 to 7, a relevance between the target search information and the target topic is greater than a preset relevance threshold.

According to one or more embodiments of the present disclosure, example 13 provides the method according to any of examples 1 to 7, after switching a current page from the first page to a search page, the method further includes:
in response to a search operation performed on the target search information, displaying, on the search page, a target search result obtained by searching based on the target search information.

According to one or more embodiments of the present disclosure, example 14 provides an apparatus for page display, including:
a page display module, configured to display a first page;
a search page switching module, configured to: in response to a search page display operation performed on the first page, switch a current page from the first page to a search page, wherein the search page is used for searching based on search information from a user; and
a target page switching module, configured to: in response to a page return operation performed on the search page, switch the current page from the search page to a target page, and display associated content of a target topic on the target page, wherein the target topic is a media content topic associated with target search information, and the target search information is search information searched by the user on the search page.

According to one or more embodiments of the present disclosure, example 15 provides an electronic device, including:
one or more processors; and
a memory communicably connected with the one or more processors, wherein
the memory stores a computer program performed by the one or more processors, and the computer program, performed by the one or more processors, causes the one or more processors to perform the method for page display according to any of examples 1 to 13.

According to one or more embodiments of the present disclosure, example 16 provides a computer-readable storage medium, storing a computer program. The program, when executed by a processor, cause the processor to perform the method for page display according to any of examples 1 to 13.

According to one or more embodiments of the present disclosure, example 17 provides a computer program product. The computer program product, when executed by a computer, causes the computer to implement the method for page display according to any of examples 1 to 13.

In addition, although multiple operations are depicted in a specific order, this should not be understood as requiring these operations to be executed in the specific order shown or in a sequential order. In certain environments, multitasking and parallel processing may be advantageous. Similarly, although a plurality of implementation details is included in the above discussion, these should not be interpreted as limiting the scope of the present disclosure. Some features described in the context of individual embodiments can also be combined and implemented in a single embodiment. On the contrary, various features that are described in the context of the single embodiment may also be implemented in a plurality of embodiments separately or in any suitable sub-combinations.

1. A method for page display, comprising:
displaying a first page;
in response to a search page display operation performed on the first page, switching a current page from the first page to a search page, wherein the search page is used for searching based on search information from a user; and
in response to a page return operation performed on the search page, switching the current page from the search page to a target page, and displaying associated content of a target topic on the target page, wherein the target topic is a media content topic associated with target search information, and wherein the target search information is search information searched by the user on the search page.

2. The method according to claim 1, wherein the target page comprises the first page, and wherein switching the current page from the search page to a target page and displaying associated content of a target topic on the target page comprises:
switching the current page from the search page to the first page, and displaying target associated prompt information of the target topic on the first page, wherein the target associated prompt information is used for prompting to watch media content associated with the target topic on a second page.

3. The method according to claim 2, wherein a page identifier of the first page and a page identifier of the second page are displayed on the first page and wherein displaying target associated prompt information of the target topic on the first page comprises:
displaying the target associated prompt information of the target topic at a display position corresponding to the page identifier of the second page, wherein the page identifier is used for triggering to display a page corresponding to the triggered page identifier.

4. The method according to claim 2, wherein displaying target associated prompt information of the target topic on the first page comprises:
in response to a total number of display times of associated prompt information of the media content topic within a current prompt cycle not reaching a preset number of times, displaying the target associated prompt information of the target topic on the first page, wherein the associated prompt information comprises the target associated prompt information.

5. The method according to claim 2, wherein after displaying target associated prompt information of the target topic on the first page, the method further comprises:
in response to a triggering operation for displaying the second page, switching the current page to the second page, and displaying target media content associated with the target topic on the second page.

6. The method according to claim 1, wherein the target page comprises a second page, and wherein switching the current page from the search page to a target page and displaying associated content of a target topic on the target page comprises:
switching the current page from the search page to the second page, and displaying target media content associated with the target topic on the second page.

7. The method according to claim 1, wherein the target page comprises a second page, and wherein in response to a page return operation performed on the search page, switching the current page from the search page to a target page, and displaying associated content of a target topic on the target page comprises:
in response to the page return operation performed on the search page, switching the current page from the search page to the first page; and
in response to a triggering operation for displaying the second page, switching the current page to the second page, and displaying target media content associated with the target topic on the second page.

8. The method according to claim 5, wherein after displaying target media content associated with the target topic on the second page, the method further comprises:
in response to a media content switching operation performed on the second page, switching the current media content displayed on the second page according to a media content stream of the second page, wherein first n media contents in the media content stream are the target media content, and n is a positive integer.

9. The method according to claim 8, wherein before displaying target media content associated with the target topic on the second page, the method further comprises:
increasing a recommendation priority corresponding to the target topic; and
generating the media content stream of the second page based on the increased recommendation priority corresponding to the target topic and recommendation priorities of other media content topics except the target topic.

10. The method according to claim 5, wherein after displaying target media content associated with the target topic on the second page, the method further comprises:
in response to a media content switching operation performed on the second page, switching the current media content displayed on the second page according to a media content stream of the second page, wherein media contents in the media content stream are the target media content.

11. The method according to claim 1, wherein switching the current page from the search page to a target page and displaying associated content of a target topic on the target page comprises:
in response to a target search result obtained by searching based on the target search information containing a target search result item, switching the current page from the search page to the target page, and displaying the associated content of the target topic on the target page, wherein region information corresponding to the target search result item is consistent with region information corresponding to the second page.

12. The method according to claim 1, wherein a relevance between the target search information and the target topic is greater than a preset relevance threshold.

13. The method according to claim 1, wherein after switching a current page from the first page to a search page, the method further comprises:
in response to a search operation performed on the target search information, displaying, on the search page, a target search result obtained by a searching operation based on the target search information.

14. (canceled)

15. An electronic device, comprising:
at least one processor; and
a memory communicably connected with the at least one processor for storing instructions executable by the at least one processor,
wherein the memory stores a computer program performed by the at least one processor, and the computer program, performed by the at least one processor, causes the at least one processor to:
display a first page;
in response to a search page display operation performed on the first page, switch a current page from the first page to a search page, wherein the search page is used for searching based on search information from a user; and
in response to a page return operation performed on the search page, switch the current page from the search page to a target page, and displaying associated content of a target topic on the target page, wherein the target topic is a media content topic associated with target search information, and wherein the target search information is search information searched by the user on the search page.

16. A non-transitory computer-readable storage medium, having computer instructions stored thereon, wherein when executed by a processor, the computer instructions cause the processor to:
display a first page;
in response to a search page display operation performed on the first page, switch a current page from the first page to a search page, wherein the search page is used for searching based on search information from a user; and
in response to a page return operation performed on the search page, switch the current page from the search page to a target page, and displaying associated content of a target topic on the target page, wherein the target topic is a media content topic associated with target search information, and wherein the target search information is search information searched by the user on the search page.

17. (canceled)

18. The electronic device according to claim 15, wherein the target page comprises the first page, and wherein the computer program causing the at least one processor to switch the current page from the search page to a target page and display associated content of a target topic on the target page comprises instructions to:
switch the current page from the search page to the first page, and displaying target associated prompt information of the target topic on the first page, wherein the target associated prompt information is used for prompting to watch media content associated with the target topic on a second page.

19. The electronic device according to claim 18, wherein a page identifier of the first page and a page identifier of the second page are displayed on the first page and wherein the computer program causing the at least one processor to display target associated prompt information of the target topic on the first page comprises instructions to:
display the target associated prompt information of the target topic at a display position corresponding to the page identifier of the second page, wherein the page identifier is used for triggering to display a page corresponding to the triggered page identifier.

20. The electronic device according to claim 18, wherein the computer program causing the processor to display target associated prompt information of the target topic on the first page comprises the instructions to:
in response to a total number of display times of associated prompt information of the media content topic within a current prompt cycle not reaching a preset number of times, display the target associated prompt information of the target topic on the first page, wherein the associated prompt information comprises the target associated prompt information.

21. The electronic device according to claim 18, wherein the computer program further comprises instructions to after displaying target associated prompt information of the target topic on the first page:
in response to a triggering operation for displaying the second page, switch the current page to the second page, and displaying target media content associated with the target topic on the second page.

22. The electronic device according to claim 15, wherein the target page comprises a second page, and wherein the computer program causing the at least one processor to switch the current page from the search page to a target page and display associated content of a target topic on the target page comprises instructions to:
switch the current page from the search page to the second page, and displaying target media content associated with the target topic on the second page.
